(19) United States
(12) Patent Application Publication
(10) Pub. No.: US 2012/0265616 A1
(43) Pub. Date: Oct. 18, 2012

(54) DYNAMIC ADVERTISING CONTENT SELECTION

(75) Inventors: Junwei Cao, Haidian District Beijing (CN); Junwei Li, Haidian District Beijing (CN)

(73) Assignee: EMPIRE TECHNOLOGY DEVELOPMENT LLC, Wilmington, DE (US)

(21) Appl. No.: 13/254,808

(22) PCT Filed: Apr. 13, 2011
(86) PCT No.: PCT/US11/32337

§ 371 Date: Sep. 2, 2011

(51) Int. Cl. G06Q 30/00

(52) U.S. Cl. 705/14.58; 705/14.49

(57) ABSTRACT

Technologies are generally described for systems and methods effective to dynamically select advertising content. In an example, target sensory content and identification information can be received for a target advertising zone. The target sensory content and the identification information can be analyzed to determine features of the target advertising zone. Based on the features meeting conditions of a predefined function, a subset of advertizing content can be determined. In some embodiments, dynamically selecting advertising content can be performed on remote computing devices. Other embodiments can render the subset of advertising content for consumption in the target advertising zone.

### TECHNICAL FIELD

The subject disclosure relates generally to dynamic selection of advertising content.

### BACKGROUND

Annually, tremendous amounts of money are spent in presenting advertising to customers. Advertising can come in visual, audio, olfactory, haptic, or other forms. One concern for advertisers is the effectiveness of communicating to consumers a particular message about a product or service. In an aspect, dynamic selection of advertising content presented to customers can play an important role in tailoring advertising to a specific customer to present a particular message in an effective manner. For example, dynamic selection of advertising content can be related to selection of a subset of advertising content from a larger set of advertising content.

Conventional advertising content is often presented in a non-dynamic fashion. For example, advertising content can be presented in a poster viewable by the public. In this example, the advertiser can make a decision on what advertising to present as a poster given the demographics of customers where the poster will be displayed. However, if the target audience matching the demographics changes or otherwise doesn't view the poster where it is displayed, the advertising may be considered less effective than it otherwise would have been. As such, it is desirable that the content of advertising can be dynamically selected, for example, to meet the changing demographics of a particular advertising region.

The above-described deficiencies of conventional approaches to advertising content selection are merely intended to provide an overview of some of the problems of conventional approaches and techniques, and are not intended to be exhaustive. Other problems with conventional systems and techniques, and corresponding benefits of the various non-limiting embodiments described herein may become further apparent upon review of the following description.

### SUMMARY

Dynamic advertising content selection can allow the presentation of advertising content to customers to communicate an advertiser's individual expressions. By gathering information about an area exposed to advertising content, a subset of advertising content can be selected that may be more relevant to consumers at, or near the area, than would be experienced with traditional static advertising. In one non-limiting example, a computing device can receive target sensory content associated with a first portion of a target advertising zone and identification information associated with an object associated with a second portion of the target advertising zone. The target sensory content and the identification information is analyzed to determine a value of a feature of the target advertising zone and determine a subset of advertising content from a set of advertising content in response to the value of the feature meeting a condition of a function.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a flow diagram illustrating an example, non-limiting embodiment for dynamically selecting advertising content based on a value of a feature for a target advertising zone.

FIG. 2 is a flow diagram illustrating an example, non-limiting embodiment for dynamically selecting advertising content based on a value of a feature for a target advertising zone.

FIG. 3 is a flow diagram illustrating an example, non-limiting embodiment for dynamically selecting advertising content based on a value of a feature for a target advertising zone.

FIG. 4 is a flow diagram illustrating an example, non-limiting embodiment for dynamically selecting advertising content based on a value of a feature for a target advertising zone.

FIG. 5 is a flow diagram illustrating an example, non-limiting embodiment for dynamically selecting advertising content based on a value of a feature for a target advertising zone.

FIG. 6 is a block diagram of an example, non-limiting embodiment of a dynamic advertising content selection system in accordance with at least some aspects of the subject disclosure.

FIG. 7 is a block diagram of an example, non-limiting embodiment of a dynamic advertising content selection system in accordance with at least some aspects of the subject disclosure.

FIG. 8 is a block diagram of an example, non-limiting embodiment of a portion of a dynamic advertising content selection system configured to determine a view area based on ocular gaze analysis in accordance with at least some aspects of the subject disclosure.

FIG. 9 is a block diagram of an example, non-limiting embodiment of a portion of a dynamic advertising content selection system configured to receive region content from a mobile device in accordance with at least some aspects of the subject disclosure.

FIG. 10 is a block diagram of an example, non-limiting embodiment of a dynamic advertising content selection system including a privacy and compliance component in accordance with at least some aspects of the subject disclosure.

FIG. 11 illustrates a flow diagram of an example, non-limiting embodiment of a set of computer readable instructions for dynamic advertising content selection in accordance with at least some aspects of the subject disclosure.

FIG. 12 is a block diagram of an example, non-limiting embodiment of a dynamic advertising content selection system in accordance with at least some aspects of the subject disclosure.

FIG. 13 is a block diagram of an example, non-limiting embodiment of a dynamic advertising content selection computing device in accordance with at least some aspects of the subject disclosure.

FIG. 14 is a block diagram of an example, non-limiting embodiment of a dynamic advertising content selection computing device in accordance with at least some embodiments of the subject disclosure.

FIG. 15 illustrates a flow diagram of an example, non-limiting embodiment of a set of computer readable instructions for dynamic advertising content selection in accordance with at least some aspects of the subject disclosure.

FIG. 16 is a block diagram illustrating an example computing device that is arranged for dynamically selecting advertising content in accordance with at least some embodiments of the subject disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the disclosure, as generally described herein, and illustrated in the Figures, can be arranged, substituted, combined, separated, and designed in a wide variety of different configurations, all of which are explicitly contemplated herein.

As computer technology evolves the concept of ubiquitous computing becomes more of a reality. Computers are involved in almost every aspect of modern life in developed countries and are becoming so in developing countries. Harnessing this widely available computing power can be of benefit to companies presenting advertising to customers. Dynamic advertising content selection can allow the presentation of advertising content to customers in a manner that may be more effective at communicating an advertiser's message. By gathering information about an area exposed to advertising content it is possible to select a subset of advertising content that may be more relevant to consumers at, or near the area, than would be experienced with traditional non-dynamic advertising.

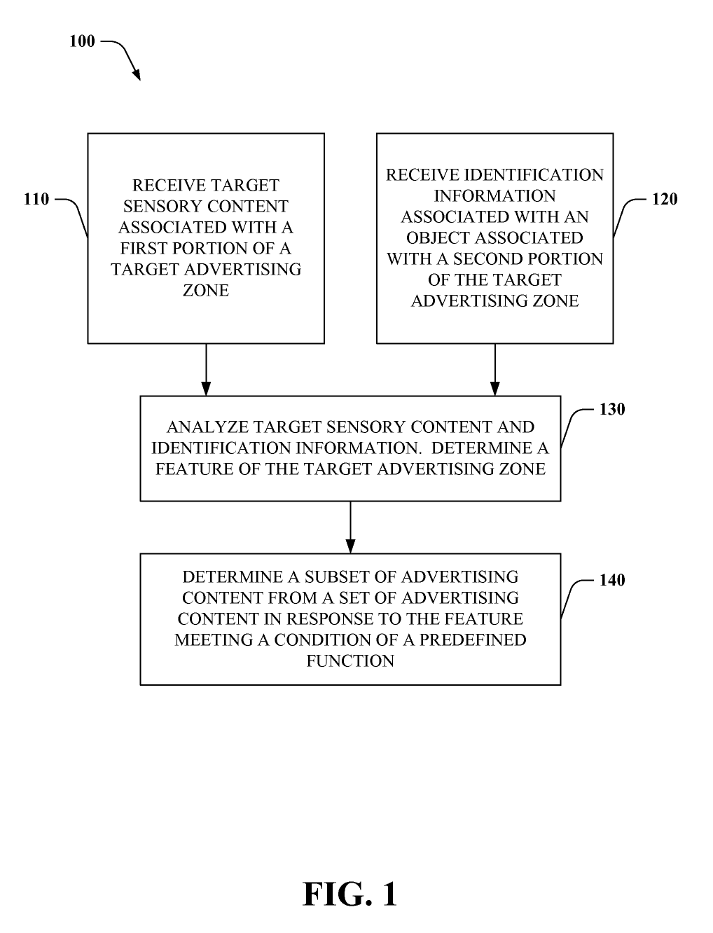

FIG. 1 is a flow diagram illustrating an example, non-limiting embodiment of a method 100, for dynamically selecting advertising content based on a value of a feature for a target advertising zone. At 110, method 100 can include receiving target sensory content associated with a first portion of a target advertising zone. Target sensory content associated with a first portion of a target advertising zone can include content typically associated with a sensory experience. For example, target sensory content can include visual, auditory, tactile, olfactory, or taste information, among others. It is to be noted that this target sensory content can be gathered by many different types of sensors, such as imaging sensors, audio sensors, pressure sensors, dynamometers, accelerometers, optical sensors, radio frequency scanners or sensors, temperature sensors, electronic noses, mass spectrometers, etc. Generally, two common forms of target sensory content include visual and audible sensory content. This content may be gathered, for example, by use of a microphone for audio content or by a camera system for visual content. Further, it will be appreciated that visual content can include still image visual content or motion image visual content, for example, snapshots or video frame grabs for still image visual content or video feeds for motion image visual content. Target sensory content can further include others types of sensor data, for example, weight, speed, humidity, temperature, vibration, etc.

A target advertising zone can be an area subject to the consumption of advertising content. This target advertising zone can be of any size. For example, a target advertising zone can include seats at a large stadium, which seats are capable of viewing a big-screen display located at one end of stadium. In a second example, a target advertising zone can include a screen on a smart phone viewable by a user or those in close proximity to the user. As a third example, a target advertising zone can include consumers queuing up at a grocery store checkout counter. Customers queuing up at the grocery store checkout counter can, for example, view a display screen with product advertisements hanging above the checkout line.

At 120, method 100 can include receiving identification information associated with an object associated with a second portion of the target advertising zone. Identification information can include information associated with a product, device, or other object. For example, identification information can include information associated with a product to buying customers, such as a barcode from a can of soup, a radio frequency identification tag from a place of clothing, or two-dimensional barcode in a catalog an individual is viewing. As a second example, identification information can include information associated with the device, such as a subscriber identity module information from a cell phone carried by an individual, an Internet protocol address associated with a mobile computer of an individual, etc. As a third example, identification information can include information associated with other objects, such as license plate information identifying a vehicle, information identifying that an individual is accompanied by a pet or child, etc.

In an aspect, the first portion of the target advertising zone can be the same as the second portion of the target advertising zone. For example, visual target sensory content can be received from a first portion of a target advertising zone including a customer and a shopping cart. In this example, identification information can be received from a second portion of the target advertising zone, where the second portion of the target advertising zone is the same as the first portion of the target advertising zone, in that, for example, barcodes for products in a shopping cart can be captured visually.

In a further aspect, the first portion of target advertising zone can be different from the second portion of the target advertising zone. For example, visual target sensory content can be received from a first portion of a target advertising zone including the torso and face of a customer and part the shopping cart. As such, it is noted that the first portion of the target advertising zone in this example does not include the entire shopping cart. Therefore, identification information, for example, barcodes for products in a shopping cart, received from the second portion of the target advertising zone, e.g., defined by the shopping cart, would be from a different portion of the target advertising zone than the first portion of the target advertising zone.

In a still further aspect, the first portion and second portion of the target advertising zone can be different and non-overlapping. For example, biomechanical target sensory content can be received from the first portion of target advertising zone including a retinal scanner a cash machine. Identification information, for example, subscriber identity module information from a cell phone, can be received from a second portion of the target advertising zone.

At 130, method 100 can include analyzing target sensory content and identification information, including determining a feature the target advertising zone. By analyzing both the target sensory content and identification information, features about the target advertising zone can be extracted that may not otherwise be available. Alternatively, target sensory content or identification information can be analyzed individually or separately. For example, where a target advertising zone includes an area around a large video display outside of a sports stadium, receiving audio target sensory content in a foreign language, for example Japanese, can indicate, or create an inference, that a tourist is viewing the video display. However, in this example, where identification information is also received indicating a long-standing US cellular phone account, the inference might instead be that the individual viewing the video display may not be a tourist after all. Where dynamic selection of advertising content is different for tourist or non-tourist, analyzing both the target sensory content and the identification information can result in a different determination about the individual viewing the large video display.

Features of the target advertising zone can include nearly any aspect of the target advertising zone. For example, a feature of the target advertising zone can be the number of people, ethnicity of the people, gender the people, inclusion of any pets, number of products, type of products, average cost of products, densities customers, spatial distribution of customers, average income of customers, identification of special customers (such as VIP customers), recent purchase information, etc. Further, features of the target advertising zone can often be quantified with the value. For example, a number of customers feature may have the value of six, where there are six people. For another example, a spatial distribution of customers feature may have a functional value, such as a function dependent on a location within the target advertising zone. Additionally, a value for feature the target advertising zone can be binary. For example, a value for a future the target advertising zone indicating the presence of children in the target advertising zone can be “true” or “false”.

At 140, method 100 can include determining a subset of advertising content from a set of advertising content in response to the value of the feature meeting a condition of a predefined function. At this point, method 100 can optionally end. As a first example of determining a subset of advertising content, where audio target sensory content is received and analyzed in conjunction with identification information for products and shopping carts, it can be determined that a predominately spoken language is Chinese and that the shopping carts include products with a high average cost per product. As such, a subset of advertising content can be selected that includes advertising in Chinese for products having a similarly high average cost per product. As a second example, where a child is detected in a target advertising zone, advertising for alcohol or tobacco can be restricted even where it would otherwise be indicated as appropriate.

One skilled in the art will appreciate that, for this and other processes and methods disclosed herein, the functions performed in the processes and methods may be implemented in differing orders. Furthermore, the outlined steps and operations are only provided as examples, and some of the steps and operations may be optional, combined into fewer steps and operations, or expanded into additional steps and operations without detracting from the disclosed embodiments.

In some embodiments, target sensory content can include content facilitating analysis of the iris or retina of individuals in that target advertising zone. This biometric information can, for example, be employed in identifying an individual and enable access to information such as purchase histories, product preferences, loyalty programs, upcoming events, allergies, familial information, etc.

Embodiments can also include ocular gaze analysis of individuals at or near a target advertising zone. Ocular gaze analysis can facilitate a determination of where an individual is looking. This can be employed at an object level in determining at what an individual is looking. As an example, the individual can be viewing a product such as a new car, an advertisement on a billboard, a piece of clothing in a store window, a coffee shop across the street, etc. Moreover, ocular gaze analysis can be employed at a sub-object level in determining a region of an object an individual is viewing. As an example, an individual can be looking at the bottom right quarter of an advertising display, where a particular class of products can be advertised that can be different from other regions of the same advertising display. As another non-limiting example, it can be determined that an individual is looking at a pop-up advertisement occupying a region of a computer display. Where these regions of an object can be determined, dynamic advertising associated with that region can be selected as part of the subset of advertising.

Moreover, embodiments can include other forms of image analysis of appropriate target sensory content. For example, analysis can include analyzing target sensory content for facial patterns. Facial patterns can be indicative of gender, ethnicity, mood, age, identity, etc. As an additional non-limiting example of image analysis, gait analysis of individuals can be performed. Gate analysis can indicate, age, speed, direction, weight, gender, etc. Numerous other image analysis techniques can be employed as part of an analysis of target sensory content and all such techniques are considered within the scope of the present disclosure despite not being enumerated herein for brevity and clarity.

Additionally, identification information can include nearly any identifier that can be related to information about the object to which the identifier is associated. As such, identification information can be indicated by radio frequency identification tags (RFIDs), a bar code, a matrix code, a multidimensional bar code, a subscriber identity module (SIM), an enhanced SIM (eSIM), a media access control (MAC) address, an Internet protocol (IP) address, an email address, a username associated with a social group of a member networking service, e.g., a username for a social media service, etc. Identification information can include object information, product information, an internet search history, an individual profile, an individual preference, demographic information, a purchase history, an advertising response history, provisioning information, schedule information, etc. For example, a smartphone eSIM can be read and used to identify an individual and can provide access to a purchase history and preference profile. As a second example, a bar code can be employed to retrieve pending order status for provisioning. Where resupply of a product is delayed in this example, dynamic advertising content can include advertisements of a comparable product.

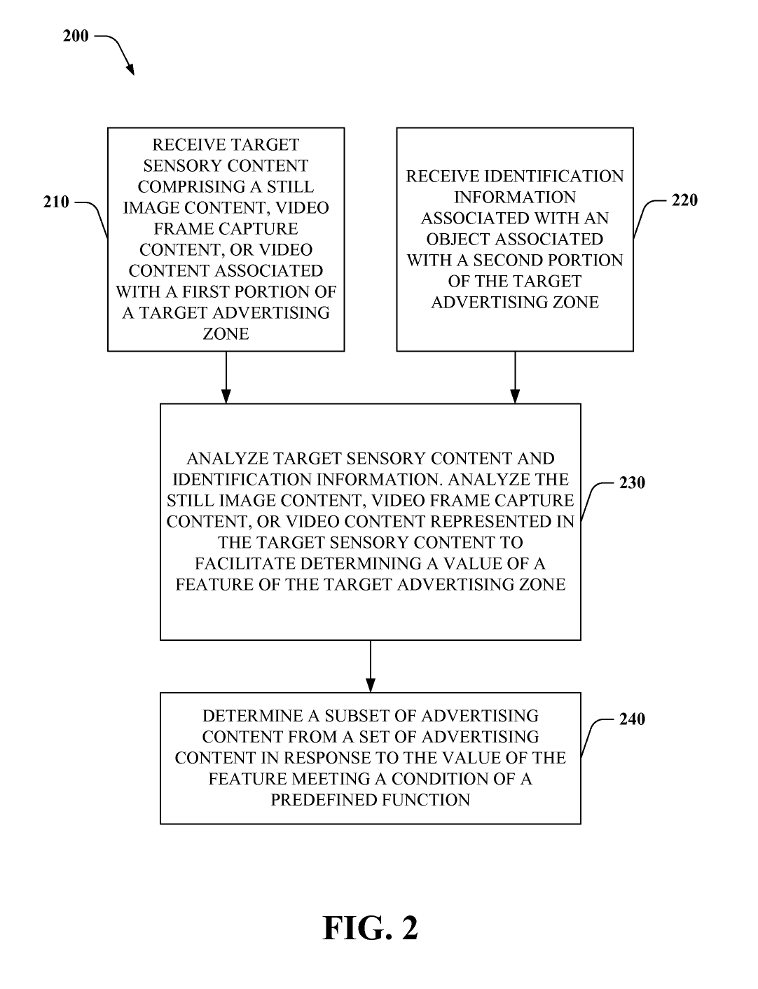

FIG. 2 is a flow diagram illustrating an example, non-limiting embodiment of a method 200, for dynamically selecting advertising content based on a value of a feature for a target advertising zone. At 210, method 200 can include receiving target sensory content comprising a still image content, video frame capture content, or video content associated with a first portion of a target advertising area. For example, method 200 can receive a still image of an iris from a camera on a cash machine. As a second example, method 200 can receive a video feed from a traffic camera, store security camera, web-cam on a computer, cell phone camera, etc. At 220, method 200 can include receiving identification information associated with an object associated with a second portion of the target advertising zone.

At 230, method 200 can include analyzing the target sensory content and identification information, including analyzing the still image, frame capture, or video content represented in the target sensory content, to facilitate determining a value of a feature of the target advertising zone. Where image content is part of the target sensory content, this image content can be analyzed in conjunction with analysis of other target sensory content and identification information. Further, where image content from multiple sources is being received, an analysis at 230 can include analysis of some or all of the image content. For example, where target sensory content includes video feed from multiple cameras, redundant areas of overlap image content can be excluded from analysis to speed up processing of the analysis. However, for the same example, the redundant areas of overlap can also be analyzed, for example, where a higher level of detail is desirable and can be gleaned from the additional analysis. As a comparative example, advertising in a food court can be associated with a large target advertising zone with a plurality of cameras supplying image target sensory content. Where, in this example, a crowd density feature is determined, redundant image content can be excluded as counting individuals may not require a high level of detail. However, in this same food court example, a gender feature is determined by facial feature analysis, the redundant image content can be valuable by providing a plurality of angles for the facial feature analysis and, as such, may not be excluded. At 240, method 200 can include determining a subset of advertising content from a set of advertising content in response to the value of the feature meeting a condition of a predefined function. At this point, method 200 can optionally end.

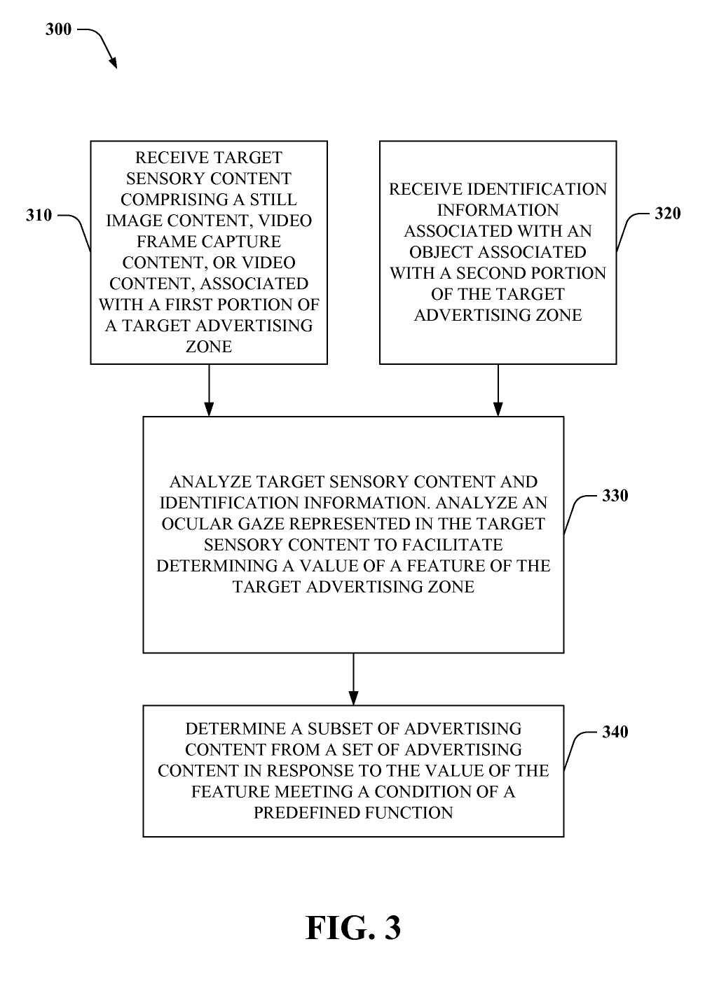

FIG. 3 is a flow diagram illustrating an example, non-limiting embodiment of a method 300, for dynamically selecting advertising content based on a value of a feature for a target advertising zone. At 310, method 300 can include receiving target sensory content comprising a still image content, video frame capture content, or video content associated with a first portion of a target advertising area. At 320, method 300 can include receiving identification information associated with an object associated with a second portion of the target advertising zone.

At 330, method 300 can include analyzing the target sensory content and identification information, including analyzing an ocular gaze represented in the target sensory content, to facilitate determining a value of a feature of the target advertising zone. Analyzing the ocular gaze can include determining a view area that can include determining an object or a region of an object that is associated with the analyzed gaze. The region of an object can include a viewable region of a presentation interface, such as a region of a computer display. As an example of ocular gaze analysis, a gaze analysis can indicate that an individual is viewing a magazine rack at store checkout counter which can indicate that audio advertising for one or more of the magazines can be appropriate. As a second example, the gaze analysis can indicate that the individual is gazing at a particular magazine title of the magazine rack, which can indicate that an advertisement for a competing magazine is appropriate. As a further, non-limiting example, a history of gaze analyses for an identified individual can be analyzed to determine a gaze trend, such as the individual gazes at potted plants when visiting a home store, which can indicate that advertising for a home store in spring can be appropriate for target advertising zones at or near the individual. Gaze analysis can also be temporal. For example, where an individual is determined to be gazing at a region of a larger advertising display, both the region and the time spent gazing at that region can be analyzed, such as an individual looking at an advertisement for several models of car can undergo a gaze analysis to track how long the individual looks at each advertised car. This can result in feature values that can dynamically populate the advertising display with cars that are deemed more likely to appeal to the individual. At 340, method 300 can include determining a subset of advertising content from a set of advertising content in response to the value of the feature meeting a condition of a predefined function. At this point, method 300 can optionally end. It is noted that numerous other aspects of gaze analysis are to be considered within the scope of the subject disclosure even though, for brevity, they are not explicitly recited herein.

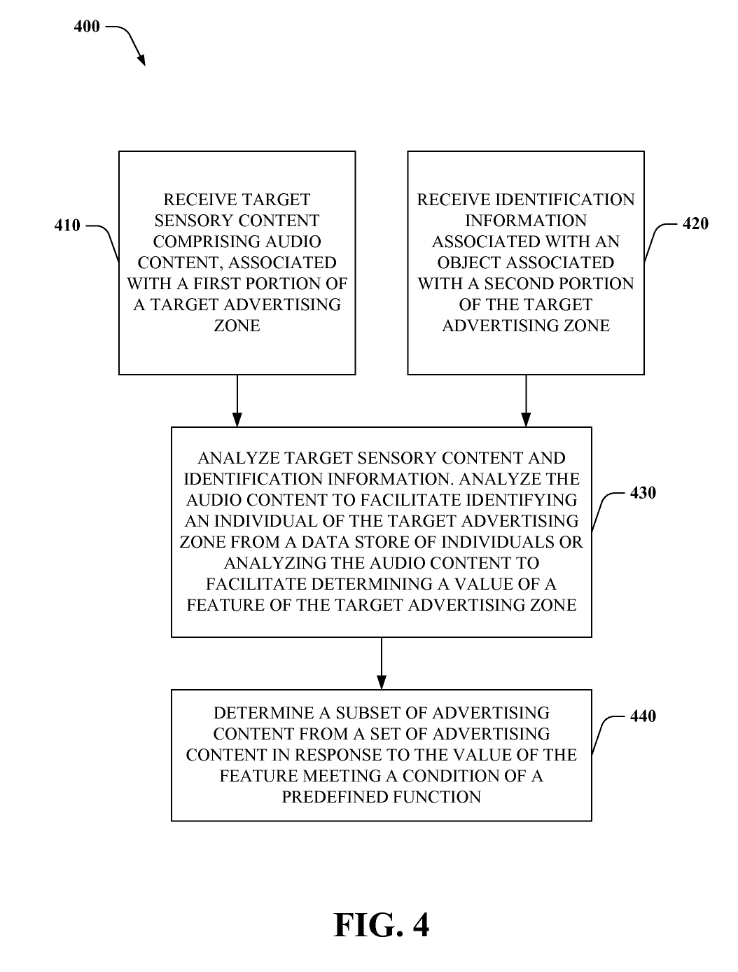

FIG. 4 is a flow diagram illustrating an example, non-limiting embodiment of a method 400, for dynamically selecting advertising content based on a value of a feature for a target advertising zone. At 410, method 400 can include receiving target sensory content comprising audio content associated with a first portion of a target advertising area. For example, method 400 can receive data representing a dialog between two people, voice content from a person, background noise such as a barking dog, foreground noise, such as a crying baby, etc. In an aspect, audio content can include removing background audio content or a defined baseline content from the received audio content. This can improve audio analysis, for example, by removing traffic noise frequencies to isolate a dialog between two people. At 420, method 400 can include receiving identification information associated with an object associated with a second portion of the target advertising zone.

At 430, method 400 can include analyzing the target sensory content and identification information, including analyzing the audio content represented in the target sensory content to facilitate identifying an individual or analyzing the audio content to facilitate determining a value of a feature of the target advertising zone. For example, where a microphone on a cell phone sources audio content, the audio content can be analyzed to try to identify the speaker or to determine the speakers language, dialect, a stress level of the speaker, etc. Further, audio content can be received from a variety of sources, including microphonic audio content captured by a microphone of an image capture device such as a webcam, a microphone of a mobile communications device such as a cell phone, a microphone of a mobile computer such as a laptop, a microphone of a mobile communications accessory such as a wireless headset, a directional array of microphones, an external microphone, etc. Additionally, non-speech audio content can also be analyzed, such as determining a volume or direction of a sound. For example, dynamic advertising content selection can promote replacement batteries for home smoke detectors in response to determining a fire truck siren is approaching a target advertising area. Similarly, advertising for headache relief products can be appropriate where road construction noises, such as jackhammers, are determined to be at or near a target advertising zone. At 440, method 400 can include determining a subset of advertising content from a set of advertising content in response to the value of the feature meeting a condition of a predefined function. At this point, method 400 can optionally end.

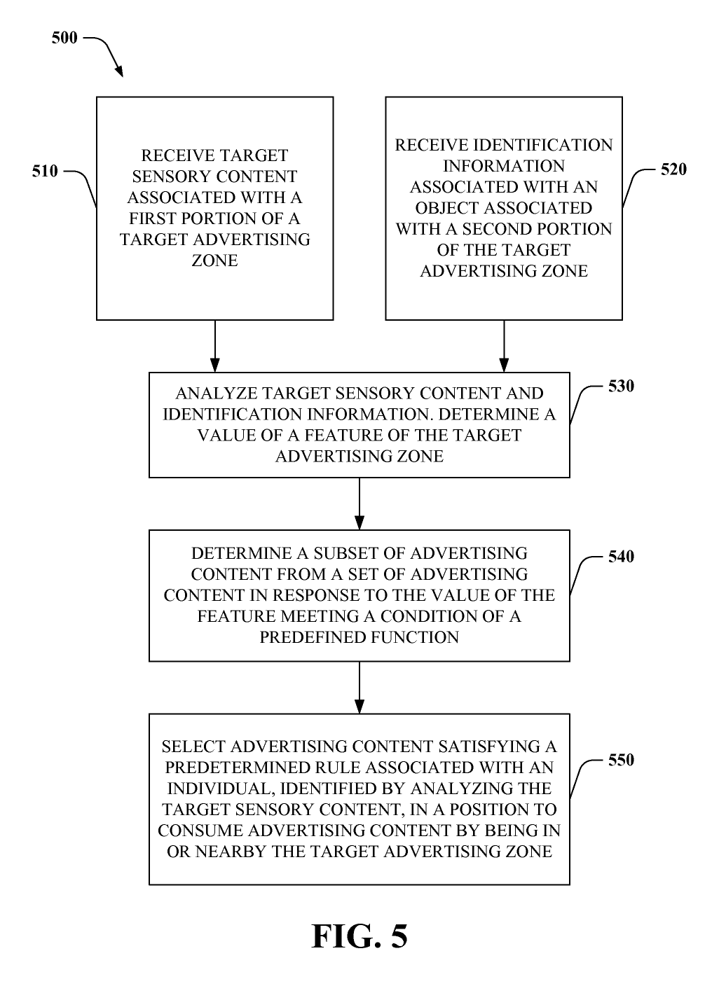

FIG. 5 is a flow diagram illustrating an example, non-limiting embodiment of a method 500, for dynamically selecting advertising content based on a value of a feature for a target advertising zone. At 510, method 500 can include receiving target sensory content associated with a first portion of a target advertising area. At 520, method 500 can include receiving identification information associated with an object associated with a second portion of the target advertising zone. At 530, method 500 can include analyzing the target sensory content and identification information including determining a value of a feature of the target advertising zone. At 540, method 500 can include determining a subset of advertising content from a set of advertising content in response to the value of the feature meeting a condition of a predefined function.

At 550, method 500 can include selecting advertising content satisfying a predetermined rule associated with an individual, identified by analyzing the target sensory content, in a position to consume advertising content by being in or nearby the target advertising zone. At this point, method 500 can optionally end. Where an individual can be identified, such as by audio and/or video analysis, rules relating to that identified individual can be employed to select advertising content from the subset of advertising content. In some embodiments, individual presence can be employed as a strong factor that can be controlling over group factors. For example, where an individual is allergic to peanuts, and that individual is identified as a part of a group of people in a target advertising zone, advertising can be restricted to only products that are certified to be free of peanut allergens. In other embodiments, individual presence can be employed as a non-factor. As an example, an individual can opt-out of dynamic advertising and therefore, when the individual is identified in a target advertising zone, selection of advertising content can intentionally ignore the features of the target advertizing zone associated with the identified individual.

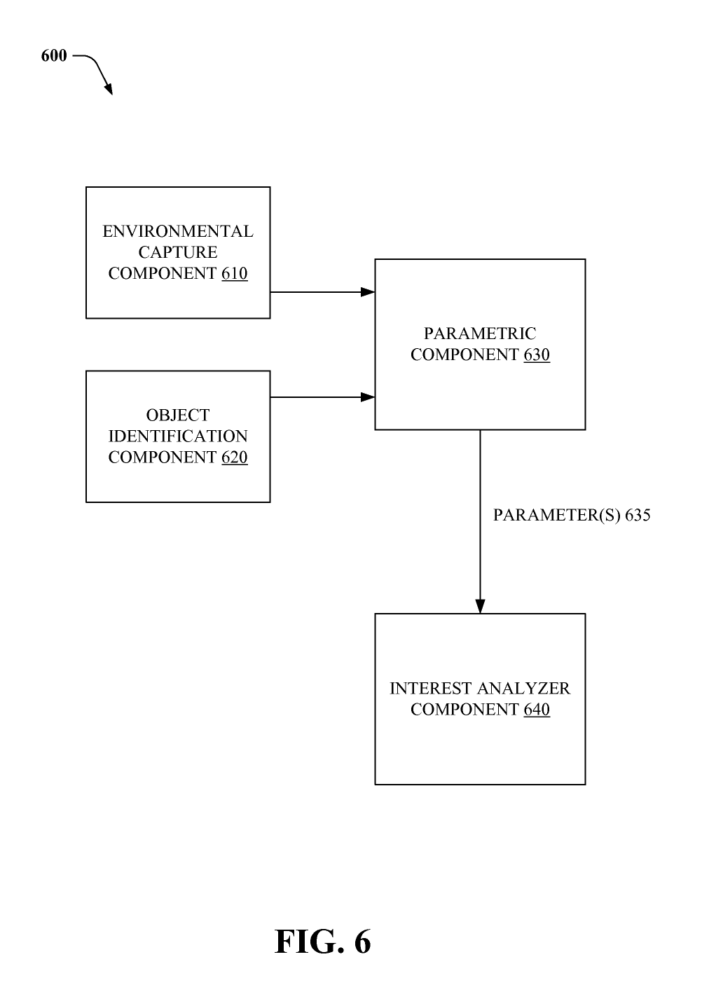

FIG. 6 is a block diagram of an example, non-limiting embodiment of a dynamic advertising content selection system 600, in accordance with at least some aspects of the subject disclosure. System 600 can include an environmental capture component 610 and an object identification component 620. Environmental capture component 610 can be configured to receive environmental content associated with a first portion of a region exposed to dynamically adapted advertising content, and can be communicatively coupled to a parametric component 630. In some embodiments, environmental capture component 610 can include a still camera, a video camera, or a video frame capture component. Further, environmental capture component 610 can include an external microphone, a directional array of microphones, a microphone associated with a video camera, a mobile communications device microphone, or a mobile device microphone. Moreover, environmental capture component 610 can be configured to receive environmental content from a remote source. Environmental content can include visual, auditory, tactile, olfactory, flavor, texture, weight, speed, humidity, temperature, vibration, etc. Environmental content can be gathered by many different types of sensors. For example, temperature content can be received from a local or remote temperature source.

In some embodiments, environmental content can include content facilitating analysis of the iris or retina of individuals. This information can, for example, be employed in identifying an individual and enable access to information such as purchase histories, product preferences, loyalty programs, upcoming events, allergies, familial information, etc. Embodiments can also include ocular gaze content of individuals. Ocular gaze content can facilitate a determination of where an individual is looking. This can be employed at an object level in determining at what an individual is looking. Moreover, ocular gaze analysis can be employed at a sub-object level in determining a region of an object an individual is viewing.

Object identification component 620 can be configured to receive object information associated with an object identifier at, or near, a second portion of the region exposed to dynamically adapted advertising content, and can be communicatively coupled to parametric component 630. In some embodiments, object identification component 620 can include a RFID reader, a bar code reader, a matrix code reader, a multidimensional bar code reader, a SIM reader, an eSIM reader, a MAC address reader, an IP address reader, an email address reader, or a reader for a username associated with a social group of a member networking service. Object information can include product information, an internet search history, an individual profile, an individual preference, demographic information, a purchase history, an advertising response history, provisioning information, schedule information, etc.

The first portion and second portion of the region exposed to dynamically adapted advertising content can be the same, different but overlapping, or different and not overlapping. For example a camera and directional microphone can capture image and audio content associated with a first portion of the region exposed to dynamically adapted advertising content, such as the torso of an individual while shopping, while a near field RFID reader can receive object information related to products in a shopping cart pushed over the RFID reader by the individual as they shop, the products in the cart being associated with a second portion of the region exposed to dynamically adapted advertising content. In this example, the first and second portion can be different and non-overlapping.

System 600 can further include parametric component 630. Parametric component 630 can be configured to analyze the environmental content and object information to determine a parameter value(s) for parameter(s) 635 for the region exposed to dynamically adapted advertising content. Parametric component 630 can be communicatively coupled to an interest analyzer component 640. In some embodiments, parametric component 630 can be configured to perform an ocular gaze analysis. The ocular gaze analysis can include a determination of a view area of the region associated with the gaze and can thereby determine an object being gazed at by an individual or a viewable region of a presentation interface component being gazed at by the individual. For example, an individual sitting at a PC can be analyzed and it can be determined that the individual is viewing a region of the display associated with a how-to article on installing a faucet while not gazing at other content located elsewhere on the display. This gaze analysis can indicate that advertising for faucets can be appropriate. Moreover, embodiments can include other forms of analysis of environmental content. For example, analysis can include analyzing environmental content for voice recognition, facial patterns, retinal patterns, iris patterns, gait analysis of individuals, language/dialect recognition, stress level analysis, volume determinations, directional determinations, etc., to determine parameter values for parameters such as demographic information parameters, purchase history parameters, preference parameters, a parameter related to an objective or preference of an individual near the advertising region, probable identification parameters, etc. Numerous other analysis techniques and parameters can be employed as part of an analysis of environmental content and all such techniques are considered within the scope of the present disclosure despite not being enumerated herein for brevity and clarity.

System 600 can further include interest analyzer component 640. Interest analyzer component 640 can be configured to determine a subset of advertising content from a set of advertising content in response to a parameter value satisfying a condition of a predefined rule. Information relating to advertising content features can be stored in an advertisement data store such that for some embodiments, interest analyzer component 640 can perform a comparison between a parameter value and an advertisement feature value to determine membership in the subset of advertising content. For example, advertising content can be classified into content categories such as vehicles, food stuffs, entertainment, etc. Interest analyzer 640, in this example, can compare a parameter value to the categories to select a subset of advertising content, such as an object identifier parameter indicating potato chips allowing rapid selection of advertising related to the food stuffs category.

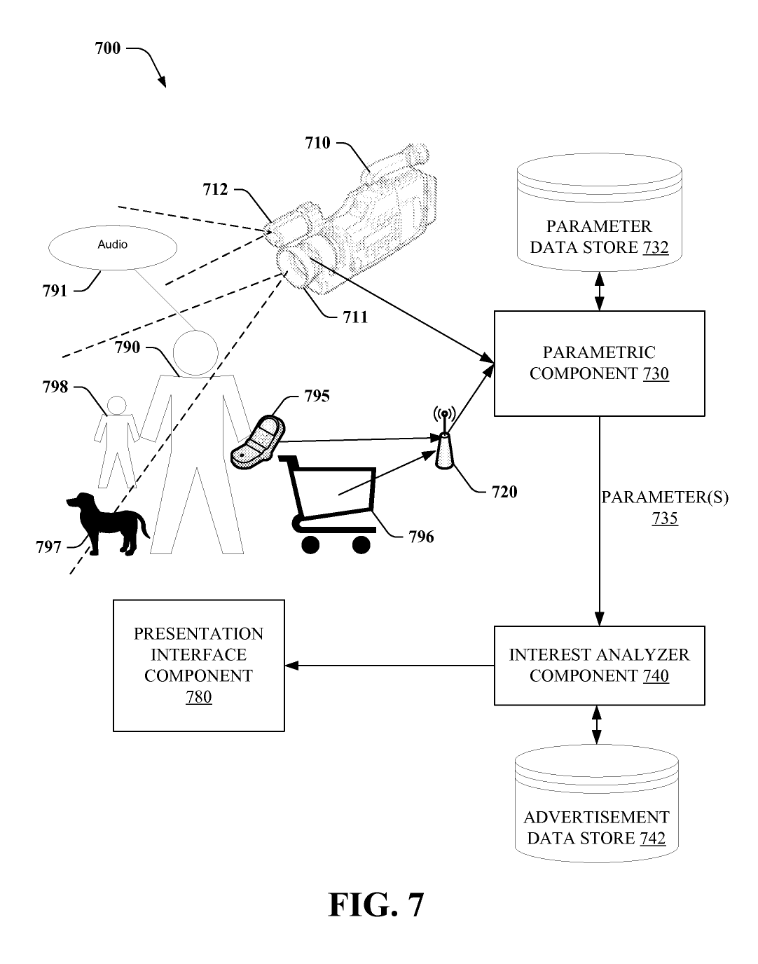

FIG. 7 is a block diagram of an example, non-limiting embodiment of a dynamic advertising content selection system 700 in accordance with at least some aspects of the subject disclosure. System 700 can include an environmental capture source 710, which can include a visual capture component 711 or an audio capture component 712. While environmental capture source 710 is illustrated as a camcorder for ease of illustration and explanation, environmental capture source 710 is not so limited. For example, environmental capture source 710 can include a security camera, a webcam, a cell phone camera, a satellite imaging system, a traffic camera, an cash machine camera, a headset microphone, a cellphone microphone, an video camera microphone, an external microphone, an array of microphones, a temperature sensor, a rain gauge, an accelerometer, a pressure sensor, an anemometer, etc. Environmental capture source 710 can be configured to receive environmental content associated with a first portion of a region exposed to dynamically adapted advertising content and can be communicatively coupled to a parametric component 730. In some embodiments, environmental capture source 710 can be configured to receive other environmental content, such as tactile, olfactory, flavor, texture, weight, speed, humidity, temperature, vibration, etc. Environmental capture source 710 can be communicatively coupled to parametric component 730.

System 700 can further include an object identification component 720. Object identification component 720 can be configured to receive object information associated with an object identifier at, or near, a second portion of the region exposed to dynamically adapted advertising content and can be communicatively coupled to parametric component 730.

Further, system 700 can include parametric component 730. Parametric component 730 can be configured to analyze the environmental content and object information to determine parameter value(s) of parameter(s) 735 for the region exposed to dynamically adapted advertising content. Parametric component 730 can be communicatively coupled to an interest analyzer component 740. Parametric component 730 can also be communicatively coupled to a parameter data store 732. Parameter data store 732 can be local, remote, or distributed data storage configured to store information pertaining to determining a parameter value. As a non-limiting example, parameter data store 732 can include iris pattern library, facial expression library, environmental content analysis rule table, etc. Further, in a ubiquitous computing environment, massive volumes of data are well within the scope of the parameter data store 732, such as individual profile dossiers for identifiable individuals, purchase histories for identifiable products, ingredient lists for products, etc.

System 700 can also include interest analyzer component 740. Interest analyzer component 740 can be configured to determine a subset of advertising content from a set of advertising content in response to a parameter value satisfying a condition of a predefined rule. Interest analyzer component 740 can be communicatively coupled to an advertisement data store 742. Advertisement data store 742 can be local, remote, or distributed data storage configured to store information pertaining to an advertisement set. As such, advertisement data store can include, for example, and advertisement content set, classification tables for advertisements of an advertisement content set, advertisement selection rule library, advertising restriction information, etc. Interest analyzer component 740 can also be communicatively coupled to a presentation interface component 780.

Presentation interface component 780 can be configured to facilitate consumption of dynamically selected advertising content in or near the region exposed to dynamically adapted advertising content. Selection of a subset of advertising content by interest analyzer component 740 can result in presentation of some of the selected subset of advertising by way of presentation interface component 780. Embodiments of presentation interface component 780 can include direct or indirect visual, audio, olfactory, palatal, or tactile presentation of advertising content. As an example, presentation interface component 780 can include a digital display for presenting visual advertising content, a speaker for providing audio advertising content, a dispensary for providing samples of an advertised product or service, a transmitter for transmitting advertising content to a target such as pushing a digital advertisement to a smartphone or email address, etc.

System 700 can interact with a region exposed to dynamically adapted advertising content. An individual 790 can, for example, be at, or near, the region. As such, individual 790 can present environmental content that can be analyzed by system 700 to facilitate a determination of a subset of advertising content. For example, visual environmental content of individual 790 can be captured by visual capture component 711. Visual capture component 711 can also capture other visual content of the region, for example, a dog 797 or a child 798, etc. Similarly, audio capture component 712 can capture audio content, such as, for example, speech 791 from individual 790.

System 700 interaction with the region can also include receiving object identification information by way of object identification component 720. For example, a cell phone 795 can provide SIM/eSIM information that can be employed to identify individuals associated with cell phone 795. For example, SIM information can identify that the phone belongs to individual 790. Further, this identification information can be associated with nearly any other type of information that can be employed by system 700 to dynamically select advertising content, for example, demographic information, preferences, purchase histories, calendar information, historic location information, familial information, etc. As another example, of receiving object identification information by way of object identification component 720, shopping cart contents 796 can provide object information for each product, for example, by way of RFID tags, to object identification component 720. For example, where shopping cart contents 796 include home theatre equipment, this information can be employed to select advertising for complimentary products or services such as speaker wires, streaming movie services, etc. Further, where analyzed in combination with environmental content, such as the facial expression and iris identification of individual 790, the selection of advertising content can be enhanced, for example, advertising for a steaming movie service can be tailored to a price point associated with individual 790, or advertising can be selected that is more calming, such as advertising a romance movie rather than an action movie, when individual 790 has facial expressions indicative of being under stress, etc.

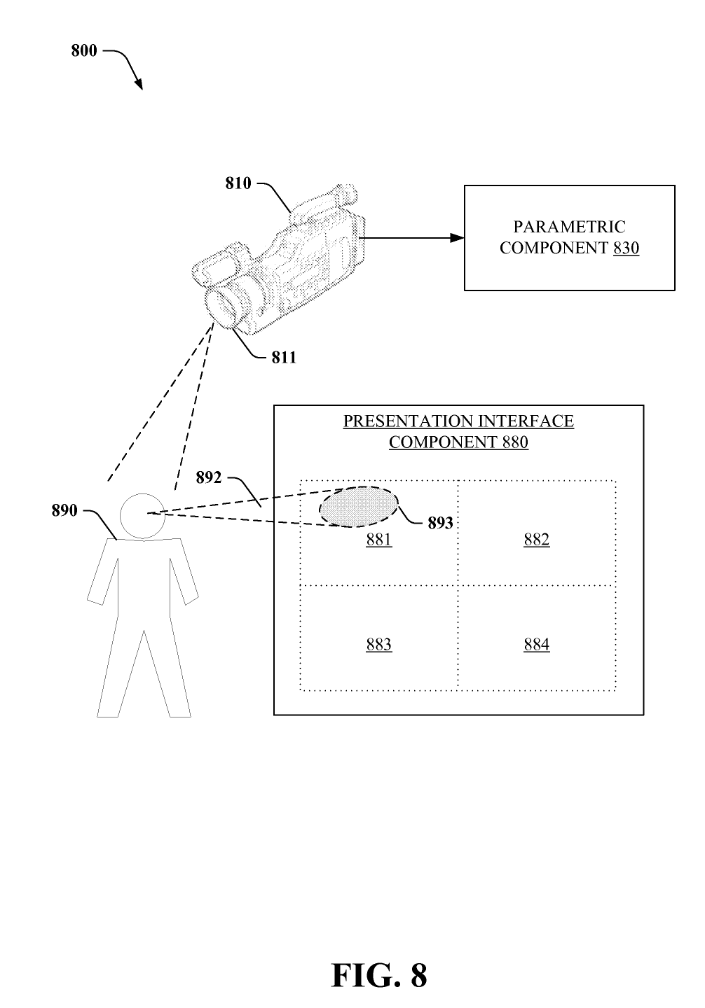

FIG. 8 is a block diagram of an example, non-limiting embodiment of a portion of a dynamic advertising content selection system 800 configured to determine a view area based on ocular gaze analysis in accordance with at least some aspects of the subject disclosure. System 800 can include an environmental capture device 810 that can include a visual capture component 811. Similar to FIG. 7, while environmental capture source 810 is illustrated as a camcorder for ease of illustration and explanation, environmental capture source 810 is not so limited. Visual capture component 811 can facilitate a parametric component 830 receiving environmental content. Parametric component 830 can be configured to analyze the environmental content to determine at least one parameter value for the region exposed to dynamically adapted advertising content, for example, by way of a presentation interface component 880.

An individual 890 can be at or near the region exposed to dynamically adapted advertising content. For example, individual 890 can be viewing presentation interface component 880. As such, individual 890 can be monitored by environmental capture device 810. Further, environmental capture device 810 can capture ocular gaze content 892 to determine a view area 893 from individual 890. For example, a convergent angle of a line drawn normal to a tangent line at the pupil of each eye of individual 890 can indicate a viewable region 881 on presentation interface component 880. Viewable region 881 can be differentiated from other regions 882, 883 and 884 where ocular gaze analysis of ocular gaze content 892 indicates a view area more strongly correlated with viewable region 881 that regions 882 to 884 of presentation interface component 880.

Similar gaze analysis can be employed to determine or identify objects individual 890 can be viewing (not illustrated). For example, environmental capture device 810 can capture ocular gaze content 892 to determine a view area 893 from individual 890. View area 893 can be correlated with an object at or near the region exposed to dynamically adapted advertising content, for example, in FIG. 8, it can be determined that individual 890 is viewing presentation interface component 880, however, it can be similarly determined that individual 890 is viewing, for example, a car, a food, clothing, a service, another individual, a cell phone, a laptop, a pet, a child, etc. As such, ocular gaze analysis can be employed to capture additional contextual information relating to environmental content of some embodiments of system 800.

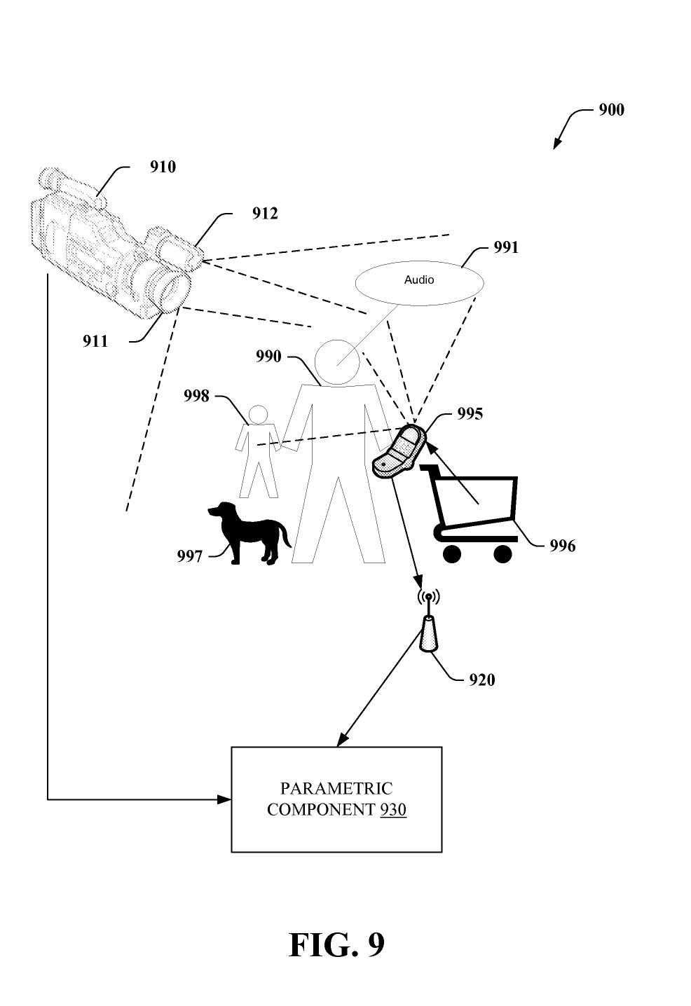

FIG. 9 is a block diagram of an example, non-limiting embodiment of a portion of a dynamic advertising content selection system 900 configured to receive region content from a mobile device in accordance with at least some aspects of the subject disclosure. System 900 can include an environmental capture device 910 that can include a visual capture component 911 and an audio capture component 912. Similar to FIG. 7, while environmental capture source 810 is illustrated as a camcorder for ease of illustration and explanation, environmental capture source 810 is not so limited. Visual capture component 911 and an audio capture component 912 can facilitate a parametric component 930 receiving environmental content. Parametric component 930 can be configured to analyze the environmental content to determine at least one parameter value for the region exposed to dynamically adapted advertising content.

Further, system 900 can include other environmental content capture components, for example, a cell phone 995. Cell phone 995 can be equipped with a camera or video system, as is common in many modern cell phones, and, as such, can capture audio content, by way of the cell phone microphone, and image content by way of the camera or video system. Cell phone 995 can be communicatively coupled to an object identification component 920. Object identification component 920 can be coupled to parametric component 930. Although not illustrated, cell phone 995 can be communicatively coupled to parametric component 930 without object identification component 920, for example, in a manner similar to the coupling of environmental capture device 910 to parametric component 930.

Cell phone 995 can capture environmental content that can be different from that captured by environmental capture device 910. For example, cell phone 995 can capture audio content from an individual 990 that can be of higher fidelity that that which would be captured by audio capture component 912. Further, cell phone 995 can be configured to capture object information, for example, from the contents of a shopping cart 996. This object information can then, for example, be relayed to object identification component 920. Moreover, cell phone 995 can capture a different scope of environmental content, for example audio content 991 and visual content of individual 990 and a child 998. Whereas cell phone 995 can be closer to individual 990 and child 998 than environmental capture device 910, the level of detail available in the environmental content, with regard to individual 990 and child 998, can be higher than that of environmental capture device 910. Further, environmental capture device 910 can be employed to capture a wider scope of environmental content than cell phone 995, for example environmental capture device 910 can capture a pet 997 which can be missed by cell phone 995. As such, the presence of pet 997 can result in population of a parameter value that can indicate that pet food advertising is appropriate. Further, where pet 997 can be positively identified and associated with a pet profile, for example, indicating that the pet is older, advertising can be further tailored, such as selecting advertising for pet food specifically formulated for older animals. Numerous other examples of additional environmental capture devices are not explicitly recited for brevity but are considered within the scope of the present disclosure.

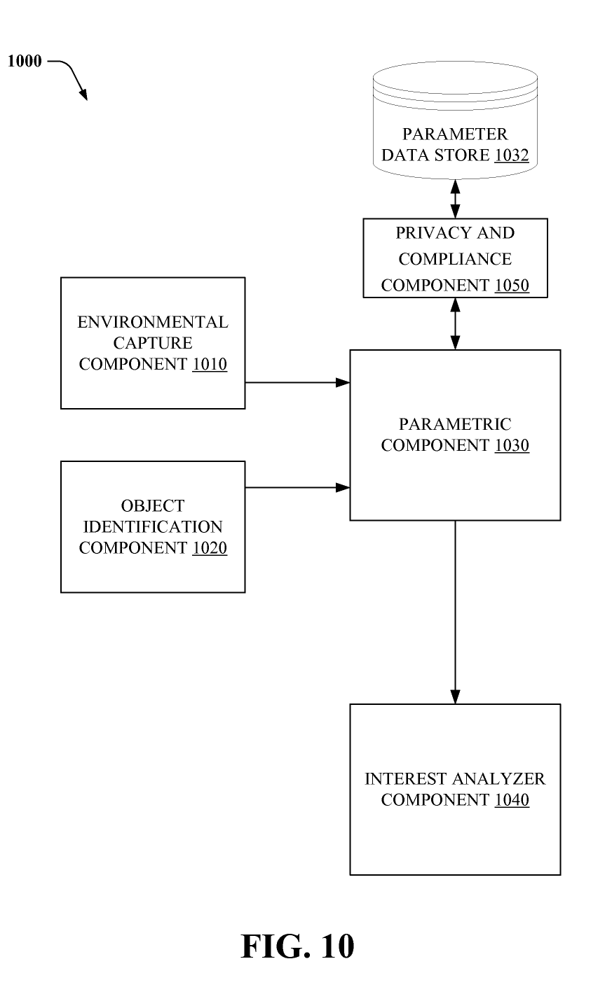

FIG. 10 is a block diagram of an example, non-limiting embodiment of a dynamic advertising content selection system 1000 including a privacy and compliance component in accordance with at least some aspects of the subject disclosure. System 1000 can include an environmental capture component 1010 and an object identification component 1020 which can be communicatively coupled to a parametric component 1030. Environmental capture component 1010 can be the same as, or similar to, environmental capture component 610. Object identification component 1020 can be the same as, or similar to, object identification component 620. Parametric component 1030 can be communicatively coupled to an interest analyzer component 1040 and a parameter data store 1032. Parametric component 1030 can be the same as, or similar to, parametric component 630. Interest analyzer component 1040 can be the same as, or similar to, interest analyzer component 640. Parameter data store 1032 can be the same as, or similar to, parameter data store 632.

System 1000 can further include a privacy and compliance component 1050. Privacy and compliance component 1050 can be communicatively disposed between parameter data store 1032 and parametric component 1030. The placement of privacy and compliance component 1050 is however, not so limited. As such, privacy and compliance component 1050 can be disposed, for example, between parametric component 1030 and interest analyzer component 1040 (not illustrated) or just as feasibly between parametric component 1030 and either, or both, environmental capture component 1010 and object identification component 1020 (not illustrated). Privacy and compliance component 1050 can be configured to restrict the subset of advertising content as a function of one or more rules defining permissible advertising. For example, the use of an individual's medical history can be forbidden in dynamic advertising, advertising alcohol or tobacco can be restricted where minors would be exposed to such advertising content, etc. Further, permissible advertising content can be restricted as a function of a protected class, such as anti-war advertising can be restricted near military funerals. Moreover, permissible advertising content can be restricted as a function of a predetermined anonymity parameter, such as limiting selected advertising in public spaces to selected classes of advertising, for example, to avoid offering dandruff shampoo to an individual while they are out for lunch with their colleagues.

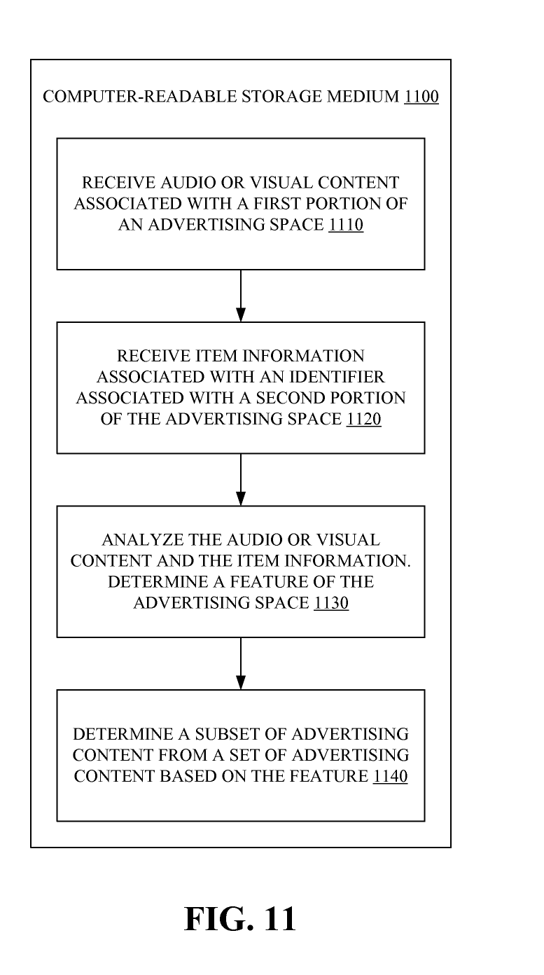

FIG. 11 illustrates a flow diagram of an example, non-limiting embodiment of a set of computer readable instructions for dynamic advertising content selection in accordance with at least some aspects of the subject disclosure. Computer-readable storage medium 1100 can include computer executable instructions. At 1110, these instructions can operate to receive audio or visual content associated with a first portion of an advertising space. Audio or visual content can be gathered by many different types of sensors, as will be appreciated by one of skill in the art. This content may be gathered, for example, by use of a microphone for audio content or by a camera system for visual content. Further, it will be appreciated that visual content can include still image visual content or motion image visual content, for example, snapshots or video frame grabs for still image visual content or video feeds for motion image visual content.

At 1120, these instructions can operate to receive item information associated with an identifier associated with a second portion of the advertising space. Item information can include information associated with a product, device, or other object. For example, item information can include information associated with a product an individual in near to, such as a barcode on a magazine, a radio frequency identification tag for a consumer electronic item, or two-dimensional barcode on a poster an individual is viewing. Item information can also include information associated with a device, such as a SIM, an IP address, a MAC address, etc. Moreover, item information can include information associated with other objects, such as street signs, building facades, logos, etc.

At 1130, instructions can operate to analyze the audio or visual content and the item information, including determining a feature of the advertising space. Features of the advertising space can include nearly any aspect of the advertising space such as population density and distribution, ethnic composition, gender composition, product information, historical personal information, individual profile information, etc. At 1140, instructions can operate to determine a subset of advertising content from a set of advertising content based on the feature determined at 1130.

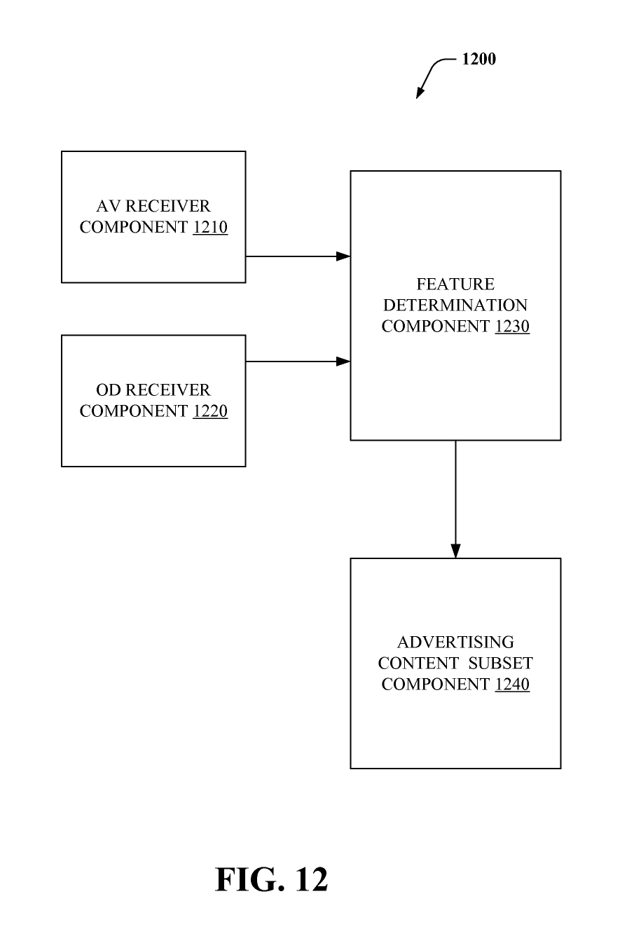

FIG. 12 is a block diagram of an example, non-limiting embodiment of a dynamic advertising content selection system 1200, in accordance with at least some aspects of the subject disclosure. System 1200 can include an AV receiver component 1210 that can be configured to receive audio content or image content related to an advertising area, and an OD receiver component 1220 that can be configured to receive object information related to an adverting area. AV receiver component 1210 can be the same as, or similar to, environmental capture component 610 or 1010, or environmental capture device 710, 810 or 910. OD receiver component 1220 can be the same as, or similar to, object identification component 620, 720, 920 or 1020.

AV receiver component 1210 and OD receiver component 1220 can be communicatively coupled to a feature determination component 1230 that can be configured to analyze the audio content or image content and the object information including an analysis to determine features associated with an advertising area. For example, image and audio analysis can discern features of the advertising area such as the presence of people, presence of animals, age of individuals present, gender of individuals present, spatial distribution of people or objects, weather conditions, time of day, seasons, speed or direction of people or objects, where the attention of people is directed or to what the attention is directed, etc. As a further example, analysis of object information can include accessing product information such as price, sales history, ingredients, target audience demographics, material safety data, replenishment status, weight, volume, complimentary items, competing items, etc. In some embodiments, features can include an interest feature. For example, where an individual in the advertising area is determined to be overweight from analysis of the individuals height, gender, and girth, and it is further determined that the individual is viewing a display of soft drinks from analysis of the logos on the packaging in front of the individual and further based on an analysis of the individual's gaze scanning over the packaging, an interest feature can be determined or inferred, such as a low calorie beverage such as a diet soft drink or water can be of interest to the individual. It is to be noted that in some embodiments, feature determination component 1230 can be the same as, or similar to, parametric component 630, 730, 830, 930, or 1030.

Feature determination component 1230 can be communicatively coupled to an advertising content subset component 1240 that can be configured to determine a subset of advertising based on the features associated with and advertising area. Features associated with an advertising area can be employed in determining a subset of advertising, such as by acting as filters, weighting variables, etc. For example, where a feature indicates an identified individual owns a king-sized bed, such as by accessing a user profile for the identified individual, and it is determined that the individual is in the bedding department of a store, the feature can be employed as a filter to select an advertising subset only relating to king-sized bedding. As a further example, where the individual has previously purchased a red king-sized duvet cover and a red sheet set, a preference feature can weight red pillow cases more favorably than blue pillow cases when selecting pillow case advertising to included in the advertizing subset. In some embodiments, the advertising content subset component 1240 can be the same as, or similar to, interest analyzer component 640, 740, or 1040.

As a more extensive, non-limiting example, where an individual is at, or near, an advertising area, the feature determination component 1230 can attempt to identify the individual, such as by image analysis to identify the individual's iris or retinal pattern. Where the individual is identified, feature determination component 1230 can receive information associated with the identified individual, for example, by receiving a product preference history for the identified individual from a remote server, the cloud, a local data store, etc. Further, feature determination component 1230 can seek to identify objects, such as products available for purchase, in the advertising area. As an example, the feature determination component 1230 can identify several health and beauty products in the advertising area, such as by image analysis of the logos on the shelved products, and as such can determine that the advertising area can be health and beauty (HABA) product related.

The identified individual's product preference history can be accessed to gather HABA product preference history. Feature determination component 1230 can then analyze the product preference history to determine, for example, an interest significance factor for HABA products. For example, the interest significance for the i^{th} commodity category, such as a HABA category, can be computed according to:

$$S ( i ) = {\sum }_{j} {e}^{- {at}_{j}} , j = 1 , 2 , … , n ,$$

where a is a predetermined scalar, n is the number of interest occurrences from the individuals product preference history and tⱼ is a time elapsed since the j^{th} interest historic occurrence. An interest occurrence can be an event recorded in the product preference history indicating that the individual engaged in a behavior indicating interest in the i^{th} product category, such as the individual looking up a coupon for a HABA product two weeks ago, the individual blogging about a HABA product two days ago, the individual purchasing a HABA product a month ago, etc. The sum of negative exponential curves forming the interest significance S(i) can be associated with a general decay in interest over time in the i^{th} category, and can be related to a ‘forgetting curve’, such as an Ebbinghaus curve.

The exemplary interest significance can be employed in determinations of advertising subsets by the advertising content subset component 1240. Where the value of the interest significance is strong, for example, it can be preferable to include HABA products in a dynamic advertisement presented to the individual, such as on the individual's mobile device. In contrast, where the interest significance is low, it can be preferable to limit HABA advertising to the individual. Further, an additional predefined scalar value, b, can be employed to amplify an individual's interest in a particular item, nᵢ, such as when the individual is gazing directly at a product, has a product in hand, is actively searching for an item online, etc. The previous equation can thus be modified to:

$$I ( i ) = {b}^{{n}_{i}} * {\sum }_{j} {e}^{- {at}_{j}} , j = 1 , 2 , … , n , and where b > 1.$$

For example, I(i) can, represent a combined interest factor and account for both a historical interest and a current interest of the identified individual in an interest category and for particular items of interest. Numerous other examples of explicitly determining features of an advertising zone and determining subsets of advertising content are not presented for brevity, although all such examples are to be considered within the scope of the subject disclosure. The preceding extensive non-limiting example is presented merely to illustrate some of the more subtle aspects of some embodiments of the present disclosure and is expressly presented without creating boundaries or restraints to the subject disclosure.

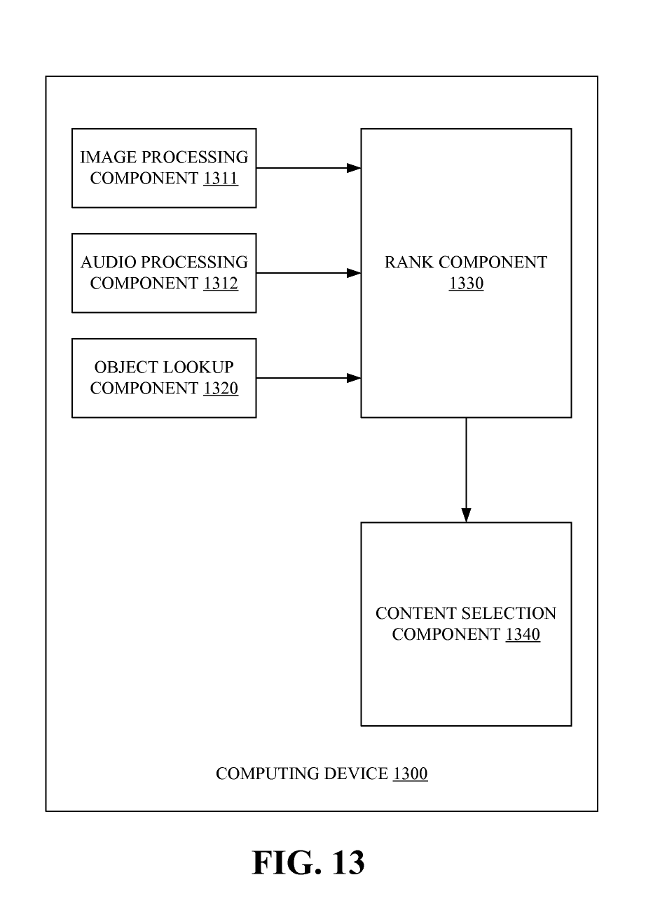

FIG. 13 is a block diagram of an example, non-limiting embodiment of a dynamic advertising content selection computing device 1300, in accordance with at least some aspects of the subject disclosure. Computing device 1300 can include an image processing component 1311 configured to receive image content from a remotely located image content source, such as a still camera, a video camera, or a video frame capture device. The image content can be associated with a first portion of a region exposed to dynamically adapted advertising content.

Computing device 1300 can further include an audio processing component 1312 configured to receive audio content from a remotely located audio content source, the audio content associated with a second portion of the region. The remotely located audio content source can include, for example, an external microphone, a directional array of microphones, a microphone associated with a video camera, a mobile communications device microphone, or a mobile device microphone.

Moreover, computing device 1300 can include an object lookup component 1320. Object lookup component 1320 can be configured to receive object information from a remotely located object information source, the object information associated with an object identifier determined to be at, or near, a third portion of the region. The remotely located object identification source can be, for example, a RFID reader, a bar code reader, a matrix code reader, a multidimensional bar code reader, a SIM reader, an eSIM reader, a MAC address reader, an IP address reader, an email address reader, or a reader for a username associated with a social group of a member networking service. Object information can include product information, an internet search history, an individual profile, an individual preference, demographic information, a purchase history, an advertising response history, provisioning information, schedule information, etc.

Image processing component 1311, audio processing component 1312, and object lookup component 1320 can be communicatively coupled to a rank component 1330. Moreover, the first portion of the region, the second portion of the region, and the third portion of the region can be the same, different but overlapping, or different and non-overlapping portions of the region in a manner similar to that described elsewhere herein.

Rank component 1330 can be configured to analyze image content, audio content, and object information, to rank features of the region according to predetermined ranking rules. Features of the region can include nearly any aspect of the region such as population density/distribution, ethnic composition, gender composition, product information, historical personal information, individual profile information, etc. Ranking rules can facilitate ordering the recognized features of the region such that a subset of advertising adapted to the features of the region can be selected. Rank component 1330 can be communicatively coupled to a content selection component 1340.

Content selection component 1340 can be configured to determine a subset of advertising content from a set of advertising content as a function of the features as ranked by rank component 1330.

As a non-limiting example, computing device can be a server-side device that receives image content, audio content, and object information content for a remotely located advertising region, ranks the features of that region and dynamically selects advertising content for that region. It will be appreciated that multiple remotely located regions can be served from the same server-side device and such a configuration can provide certain advantages. For example, a server-side device can serve dynamically selected advertising content to a plurality of remotely located advertising regions in a single store or venue, across a plurality of stores or venues, regionally, or at any other level of granularity.

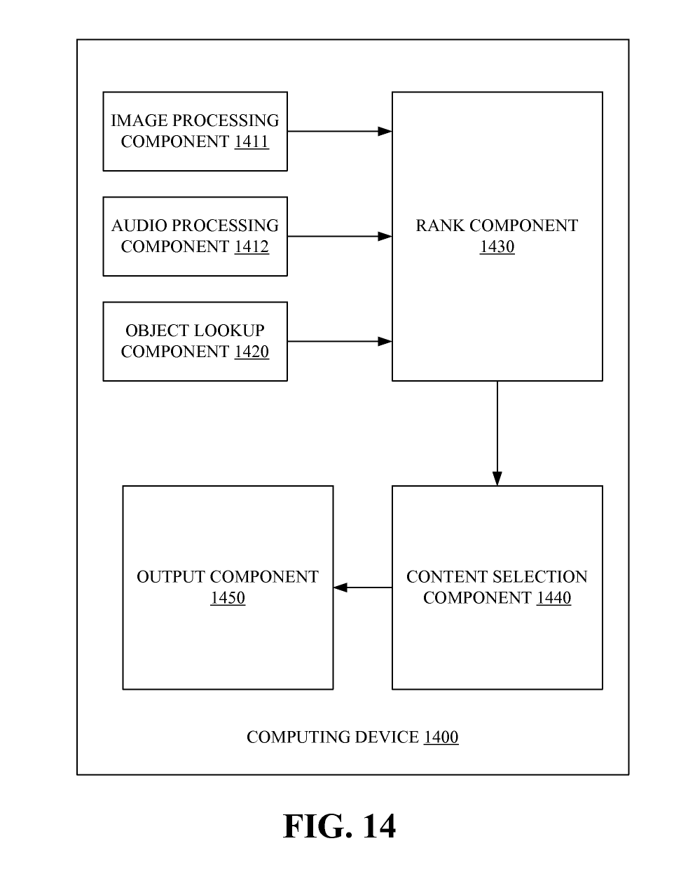

FIG. 14 is a block diagram of an example, non-limiting embodiment of a dynamic advertising content selection computing device 1400, in accordance with at least some embodiments of the subject disclosure. Computing device 1400 can include an image processing component 1411 configured to receive image content from a remotely located image content source, such as a still camera, a video camera, or a video frame capture device. The image content can be associated with a first portion of a region exposed to dynamically adapted advertising content. Image processing component 1411 can be the same as, or similar to, image processing component 1311.

Computing device 1400 can also include an audio processing component 1412 configured to receive audio content from a remotely located audio content source, the audio content associated with a second portion of the region. Audio processing component 1412 can be the same as, or similar to, audio processing component 1312.

Computing device 1400 can further include an object lookup component 1420. Object lookup component 1420 can be configured to receive object information from a remotely located object information source, the object information associated with an object identifier determined to be at, or near, a third portion of the region. Object lookup component 1420 can be the same as, or similar to, object lookup component 1320.

Image processing component 1411, audio processing component 1412, and object lookup component 1420 can be communicatively coupled to a rank component 1430. Rank component 1430 can be configured to analyze image content, audio content, and object information, to rank features of the region according to predetermined ranking rules. Rank component 1430 can be the same as, or similar to, rank component 1330. Rank component 1430 can be communicatively coupled to a content selection component 1440 configured to determine a subset of advertising content from a set of advertising content as a function of the features as ranked by rank component 1430. Content selection component 1440 can be the same as, or similar to, content selection component 1340.

Content selection component 1440 can be communicatively coupled to an output component 1450. Output component can be local to computing device 1400, as illustrated, or can be remotely located (not illustrated). In an embodiment output component 1450 can be configured to facilitate access to the subset of advertising content for presentation in the region exposed to dynamically adapted advertising content. For example, where computing device 1400 can be a server side device, output component 1450 can provide for access to the determined subset of advertising content by, for example, a remotely located display of the region exposed to dynamically adapted advertising content. In another embodiment, output component 1450 can be configured to render the subset of advertising content in the region exposed to dynamically adapted advertising content. As an example, rendering the subset of advertising can be part of streaming the advertising content to a mobile device located at or near the region exposed to dynamically adapted advertising content.

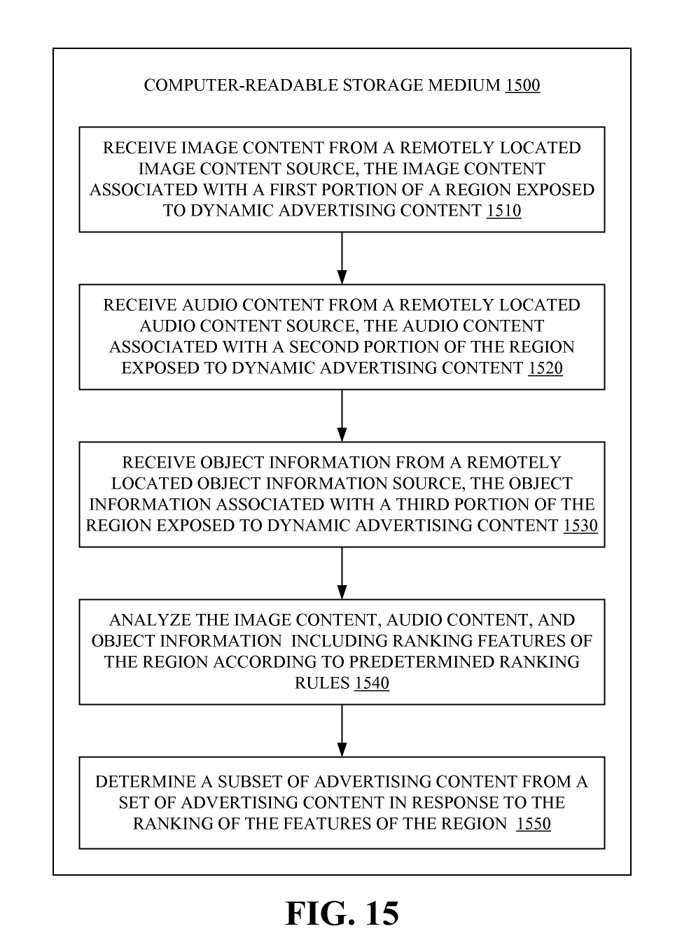

FIG. 15 illustrates a flow diagram of an example, non-limiting embodiment of a set of computer readable instructions for dynamic advertising content selection in accordance with at least some aspects of the subject disclosure. Computer-readable storage medium 1500 can include computer executable instructions. At 1510, these instructions can operate to receive image content from a remotely located image content source, the image content associated with a first portion of region exposed to dynamic advertising content. At 1520, instructions can operate to receive audio content from a remotely located audio content source, the audio content associated with a second portion of region exposed to dynamic advertising content. Image content and audio content can be gathered by many different types of remote sensors as disclosed herein. Content can be gathered, for example, by use of a microphone for audio content or by a camera system for image content. Further, it will be appreciated that image content can include still image visual content or motion image visual content.

At 1530, instructions can operate to receive object information from a remotely located object information source, the object information associated with a third portion of region exposed to dynamic advertising content. The first portion of the region, the second portion of the region, and the third portion of the region can be the same, different but overlapping, or different and non-overlapping portions of the region in a manner similar to that described elsewhere herein. Object information can include information associated with a product, device, or other object. For example, object information can include information associated with products in the region, such as a RFID tags for products in a showroom. Object information can also include information associated with a device, such as a SIM, an IP address, a MAC address, etc. Further, object information can include information associated with other objects, such as pets, trees, weather, etc.

At 1540, instructions can operate to analyze the image content, audio content, and the object information, including ranking features of the region according to predetermined ranking rules. Features of the region can include nearly any aspect of the advertising space such as population density and distribution, ethnic composition, gender composition, product information, historical personal information, individual profile information, etc. At 1550, instructions can be for determining a subset of advertising content from a set of advertising content in response to the ranking of the features of the region.

As a non-limiting example, computer readable storage medium 1500 can include computer readable instructions for a server-side computer that, in response to execution the instructions, cause the server-side computer to perform operations to receive image content, audio content, and object information content for a remotely located advertising region, rank the features of that region and dynamically select advertising content for that region.

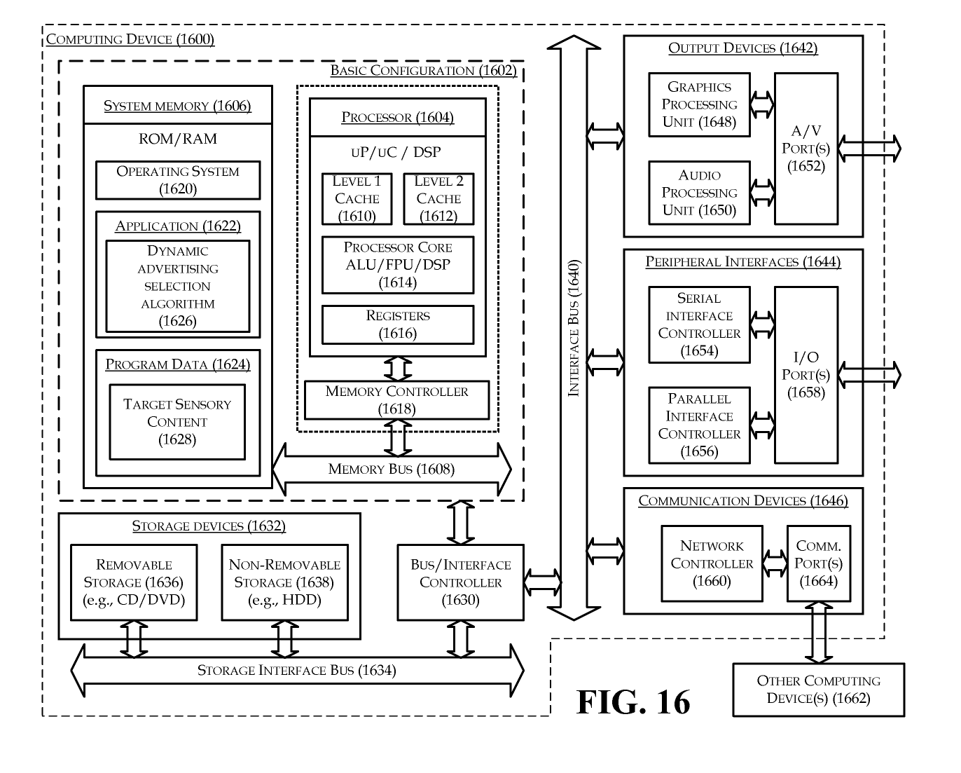

FIG. 16 is a block diagram illustrating an example computing device 1600 that is arranged for dynamically selecting advertising content in accordance with at least some embodiments of the subject disclosure. In a very basic configuration 1602, computing device 1600 typically includes one or more processors 1604 and a system memory 1606. A memory bus 1608 may be used for communicating between processor 1604 and system memory 1606.

Depending on the desired configuration, processor 1604 may be of any type including but not limited to a microprocessor (μP), a microcontroller (μC), a digital signal processor (DSP), or any combination thereof. Processor 1604 may include one more levels of caching, such as a level one cache 1610 and a level two cache 1612, a processor core 1614, and registers 1616. An example processor core 1614 may include an arithmetic logic unit (ALU), a floating point unit (FPU), a digital signal processing core (DSP Core), or any combination thereof. An example memory controller 1618 may also be used with processor 1604, or in some implementations memory controller 1618 may be an internal part of processor 1604.

Depending on the desired configuration, system memory 1606 may be of any type including but not limited to volatile memory (such as RAM), non-volatile memory (such as ROM, flash memory, etc.) or any combination thereof. System memory 1606 may include an operating system 1620, one or more applications 1622, and program data 1624. Application 1622 may include a dynamic advertising selection algorithm 1626 that is arranged to perform the functions as described herein including those described with respect to dynamic advertising selection system 600 of FIG. 6. Program data 1624 may include target sensory content 1628 that may be useful for operation with a dynamic advertising selection algorithm 1626 as is described herein. In some embodiments, application 1622 may be arranged to operate with program data 1624 on operating system 1620 such that dynamic advertising selection may be provided as described herein. This described basic configuration 1602 is illustrated in FIG. 16 by those components within the inner dashed line.

Computing device 1600 may have additional features or functionality, and additional interfaces to facilitate communications between basic configuration 1602 and any required devices and interfaces. For example, a bus/interface controller 1630 may be used to facilitate communications between basic configuration 1602 and one or more data storage devices 1632 via a storage interface bus 1634. Data storage devices 1632 may be removable storage devices 1636, non-removable storage devices 1638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1606, removable storage devices 1636 and non-removable storage devices 1638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 1600. Any such computer storage media may be part of computing device 1600.

Computing device 1600 may also include an interface bus 1640 for facilitating communication from various interface devices (e.g., output devices 1642, peripheral interfaces 1644, and communication devices 1646) to basic configuration 1602 via bus/interface controller 1630. Example output devices 1642 include a graphics processing unit 1648 and an audio processing unit 1650, which may be configured to communicate to various external devices such as a display or speakers via one or more A/V ports 1652. Example peripheral interfaces 1644 include a serial interface controller 1654 or a parallel interface controller 1656, which may be configured to communicate with external devices such as input devices (e.g., keyboard, mouse, pen, voice input device, touch input device, etc.) or other peripheral devices (e.g., printer, scanner, etc.) via one or more I/O ports 1658. An example communication device 1646 includes a network controller 1660, which may be arranged to facilitate communications with one or more other computing devices 1662 over a network communication link via one or more communication ports 1664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 1600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1600 may also be implemented as a personal computer including both laptop computer and non-laptop computer configurations.

The subject disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The subject disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the subject disclosure have been described herein for purposes of illustration, and that various modifications may be made without departing from the scope and spirit of the subject disclosure. Accordingly, the various embodiments disclosed herein are not intended to be limiting, with the true scope and spirit being indicated by the following claims.

1. A method, comprising:
receiving, by at least one computing device, target sensory content associated with at least a first portion of a target advertising zone;
receiving, by the at least one computing device, identification information associated with at least one object associated with at least a second portion of the target advertising zone;
analyzing the target sensory content and the identification information including determining at least one value of at least one feature of the target advertising zone; and
determining a subset of advertising content from a set of advertising content in response to the at least one value of the least one feature meeting a condition of a pre-defined function.

2. The method of claim 1, wherein the receiving the target sensory content comprises receiving image content of at least the first portion of the target advertising zone.

3-7. (canceled)

8. The method of claim 1, wherein the analyzing includes identifying or classifying non-human animals as a function of the at least one value of the at least one feature.

9. The method of claim 1, wherein the analyzing includes identifying or classifying human beings as a function of the at least one value of the at least one feature.

10. The method of claim 1, wherein the analyzing comprises analyzing to determine the at least one value of the at least one feature for a plurality of entities in the target advertising zone not present in a defined baseline content of the target advertising zone without the plurality of entities.

11. The method of claim 1, wherein the receiving the target sensory content associated with at least the first portion of the target advertising zone comprises receiving audio content of at least the first portion of the target advertising zone.

12-13. (canceled)

14. The method of claim 1, wherein the receiving the identification information associated with at least one object includes receiving at least one of a radio frequency identification tag, a bar code, a matrix code, a multidimensional bar code, a subscriber identity module, an enhanced subscriber identity module, a media access control address, an Internet protocol address, an email address, or a username associated with a social group of a member networking service.

15. The method of claim 1, wherein the receiving the identification information comprises at least one of receiving object information, receiving product information, receiving an internet search history, receiving an individual profile, receiving an individual preference, receiving demographic information, receiving a purchase history, receiving an advertising response history, receiving provisioning information, or receiving individual schedule information.

16. The method of claim 1, wherein the analyzing comprises at least one of determining demographic information related to an individual of the target advertising zone, determining a purchase preference of an individual of the target advertising zone, or determining a historical advertising response of an individual of the target advertising zone.

17. The method of claim 1, wherein the receiving the identification information includes receiving the identification information associated with the at least one object associated with the second portion of the target advertising zone that is different than the first portion of the target advertising zone.

18. The method of claim 1, wherein the receiving the identification information includes receiving the identification information associated with the at least one object associated with a portion of the target advertising zone that is non-overlapping with the first portion of the target advertising zone.

19. The method of claim 1, wherein the determining the subset of advertising content further comprises selecting advertising content satisfying a predetermined rule associated with at least one individual, identified by the analyzing the target sensory content, in a position to consume advertising content by being in or nearby the target advertising zone.

20. (canceled)

21. A system, comprising:
an environmental capture component configured to receive environmental content associated with at least a first portion of a region exposed to dynamically adapted advertising content;
an object identification component configured to receive object information associated with at least one object identifier at, or near, at least a second portion of the region;
a parametric component configured to analyze the environmental content and object information to determine at least one parameter value of a set of parameters for the region; and
an interest analyzer component configured to determine a subset of advertising content from a set of advertising content in response to the at least one parameter value satisfying a condition of a predefined rule.

22. The system of claim 21, further comprising a presentation interface component configured to present the subset of advertising content.

23. The system of claim 22, wherein the presentation interface component comprises an image interface, a video interface, an audio interface, a haptic interface, or an olfactory interface.

24. The system of claim 21, wherein the environmental capture component comprises a still camera, a video camera, or a video frame capture component.

25. The system of claim 21, wherein the environmental capture component comprises an external microphone, a directional array of microphones, a microphone associated with a video camera, a mobile communications device microphone, or a mobile computing device microphone.

26. The system of claim 21, wherein the object identification component comprises at least one of a radio frequency identification reader, a bar code reader, a matrix code reader, a multidimensional bar code reader, a subscriber identity module reader, an enhanced subscriber identity module reader, a media access control address reader, an Internet protocol address reader, an email address reader, or a reader for a username associated with a social group of a member networking service.

27. The system of claim 21, wherein the parametric component is configured to perform an ocular gaze analysis to determine the at least one parameter value.

28-30. (canceled)

31. The system of claim 21, wherein the parametric component is configured to converge on an identity of at least one individual located proximate to the region.

32-33. (canceled)

34. The system of claim 21, wherein the parametric component is configured to determine at least one of a language associated with audio input from the region, a dialect of the language, a stress level associated with the audio input, a volume of the audio input, or a direction associated with the audio input to facilitate in a determination of at least one perception parameter value of at least one individual located proximate to the region.

35. The system of claim 21, wherein the interest analyzer component is configured to receive at least one advertising feature value from an advertisement data store and to perform a comparison of at least a subset of the at least one parameter value and at least a subset of the at least one advertising feature value to facilitate selection of at least one advertisement for the subset of advertising content wherein a result of the comparison satisfies at least one predetermined function.

36. The system of claim 21, further comprising a privacy and compliance component configured to restrict the subset of advertising content as a function of an age of an object identified in the region, a protected class of the object identified in the region, a predetermined anonymity parameter of the object identified in the region, or conformance by the object identified in the region with at least one rule defining permissible advertising content.

37. The system of claim 21, wherein the parametric component is distributed across a plurality of computers in a distributed computing environment.

38. The system of claim 21, wherein the interest analyzer component is distributed across a plurality of computers in a distributed computing environment.

39. A computer-readable storage medium having stored thereon computer-executable instructions that, in response to execution, cause a computing device to perform operations, comprising:
receiving at least one of audio content or visual content associated with at least a first portion of an advertizing space associated with consumption of advertising content;
receiving item information associated with at least one identifier associated with at least a second portion of the advertising space;
analyzing the at least one of the audio content or the visual content, and the item information including determining at least one feature of the advertising space; and
determining a subset of advertising content from a set of advertising content based on the at least one feature.

40. A system, comprising:
means for receiving at least one of audio content or image content associated with at least an individual at, or near, an advertising area associated with consuming advertising content;
means for receiving object information associated with at least one identifier at, or near, the advertising area;
means for analyzing the at least one of the audio content or the image content, and the object information including determining at least one feature of the advertising area; and
means for determining a subset of advertising content from a set of advertising content based on the at least one feature.

41-46. (canceled)
